(19) United States
(12) Patent Application Publication
(10) Pub. No.: US 2026/0162329 A1
(43) Pub. Date: Jun. 11, 2026

(54) DATA PROCESSING METHOD, ELECTRONIC DEVICE, AND STORAGE MEDIUM

(71) Applicant: Lenovo (Beijing) Limited, Beijing (CN)

(72) Inventor: Ying GAO, Beijing (CN)

(21) Appl. No.: 19/178,495

(22) Filed: Apr. 14, 2025

(30) Foreign Application Priority Data
Apr. 17, 2024 (CN) 202410465786.8

(51) Int. Cl. G06T 11/60

(52) U.S. Cl. CPC G06T 11/60

(57) ABSTRACT

A data processing method includes obtaining attribute description information of one or more target sub-objects, the one or more target sub-objects including one or more of at least one sub-object configured to generate a target object; and generating a target file including the target object according to the attribute description information. The attribute description information indicates presentation effects of the target sub-objects in the target file.

### CROSS-REFERENCE TO RELATED APPLICATION

This application claims priority to Chinese Patent Application No. 202410465786.8, filed on Apr. 17, 2024, the entire content of which is incorporated herein by reference.

### TECHNICAL FIELD

The present disclosure generally relates to the field of artificial intelligence technologies and, more particularly, to a data processing method and device.

### BACKGROUND

Artificial intelligence generated content (AIGC) is an artificial intelligence technology configured to automatically generate a variety of content, including text, code, images, audio, video, etc. At present, when AIGC is configured to generate required content such as images, the generated content is difficult to meet the users'real needs.

### SUMMARY

One embodiment of the present disclosure includes a data processing method. The method includes obtaining attribute description information of one or more target sub-objects, he one or more target sub-objects including one or more of at least one sub-object configured to generate a target object; and generating a target file including the target object according to the attribute description information. The attribute description information is configured to indicate presentation effects of the target sub-objects in the target file.

Another embodiment of the present disclosure includes an electronic device. The electronic device includes one or more processors; and a memory containing at least one instruction that, when being executed, causes the one or more processors to perform: obtaining attribute description information of one or more target sub-objects, he one or more target sub-objects including one or more of at least one sub-object configured to generate a target object; and generating a target file including the target object according to the attribute description information. The attribute description information is configured to indicate presentation effects of the target sub-objects in the target file.

Another embodiment of the present disclosure includes a non-transitory computer readable storage medium containing at least one instruction that, when being executed, causes at least one processor to perform: obtaining attribute description information of one or more target sub-objects, he one or more target sub-objects including one or more of at least one sub-object configured to generate a target object; and generating a target file including the target object according to the attribute description information. The attribute description information indicates presentation effects of the target sub-objects in the target file.

### BRIEF DESCRIPTION OF THE DRAWINGS

FIG. 1 is a flow chart of a data processing method consistent with various embodiments of the present disclosure.

FIG. 2 is a schematic diagram of performing AI image generation.

FIG. 3 is a flowchart of another data processing method consistent with various embodiments of the present disclosure.

FIG. 4 is an exemplary target sub-object and its attribute description information consistent with various embodiments of the present disclosure.

FIG. 5 is a schematic diagram of an example of an image generated in FIG. 4 consistent with various embodiments of the present disclosure.

FIG. 6 is a flowchart of another data processing method consistent with various embodiments of the present disclosure.

FIG. 7 is a flowchart of another data processing method consistent with various embodiments of the present disclosure.

FIG. 8A and FIG. 8B are two other exemplary target sub-objects and their attribute description information consistent with various embodiments of the present disclosure.

FIG. 8C is a schematic diagram of an example of an image generated in FIG. 8A and FIG. 8B consistent with various embodiments of the present disclosure.

FIG. 9A is another exemplary target sub-object and attribute description information consistent with various embodiments of the present disclosure.

FIG. 9B is a schematic diagram of an example of an image generated in FIG. A consistent with various embodiments of the present disclosure.

FIG. 10 is a schematic structural diagram of a data processing device consistent with various embodiments of the present disclosure.

FIG. 11 is a schematic structural diagram of an electronic device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

The present disclosure provides a data processing method and device to at least partially alleviate the problem that the generated content is difficult to meet the real needs of users when using artificial intelligence models such as AIGC to generate content in existing technologies. The data processing method provided by the present disclosure may be used for electronic devices under many general or special computing device environments or configurations, such as personal computers, server computers, handheld devices or portable devices, tablet devices, multi-processor devices, etc.

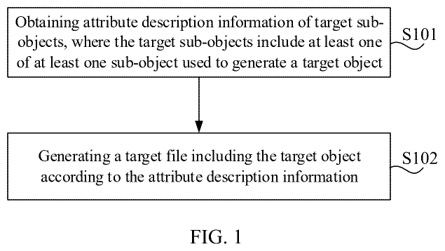

In one embodiment, as shown in FIG. 1 which is a flowchart of a data processing method flow consistent with the present disclosure, the data processing method may include S101 and S102.

At S101, attribute description information of target sub-objects is obtained, where the target sub-objects include at least one of at least one sub-object configured to generate a target object.

The target object may be, but is not limited to, various types of content objects such as images, audio, video, slides, or documents. The at least one sub-object configured to generate the target object may include, but is not limited to, at least one sub-object for generating content objects such as images, audio, or video. For example, the at least one sub-object may include but is not limited to local lines, local areas, or image drawing sketches for generating images, voice clips for generating audio, or video material clips for generating videos, etc.

The target sub-objects may include at least one of the at least one sub-object configured to generate the target object. Optionally, the target sub-objects may include sub-objects matching attribute setting requirements selected or specified by a user from the at least one sub-object configured to generate the target object based on a corresponding selection/specification operation. The number of target sub-objects may be one or more, without limitation, depending on actual needs.

The user may select or specify the required number of target sub-objects from the at least one sub-object configured to generate the target object through any one or more selection/specification operations such as box selection, point selection, text input, voice input, etc., and set attributes for them, to generate attribute description information for the target sub-objects through the attribute setting operation.

The attribute description information may be configured to indicate the presentation effects of the target sub-objects in the target file.

Optionally, the presentation effect may be the output effect of the target sub-objects (such as local lines, local areas, etc. of an image) in the target file when the target file is output, or may be the presentation effect of the target sub-objects in the target file when the target file is shared or otherwise processed, depending on actual needs. Generally, it mainly refers to the output effect of the target sub-objects in the target file when the target file is output, such as the color, brightness, rendering effect, etc. of the local lines or local areas of the image.

The attribute description information of the target sub-objects may include, but is not limited to, any one or more of display attribute description information, audio attribute description information, action attribute description information, change attribute description information, etc. of the target sub-objects.

Exemplarily, the display attribute description information of the target sub-objects may include, but is not limited to, the color, saturation, brightness, display style, rendering effect, size ratio between the target sub-objects and other connected sub-objects, or combination characteristics with other connected sub-objects (such as the relative angle or relative direction between the target sub-object and other connected sub-objects), etc. The audio attribute description information of the target sub-objects may include but is not limited to volume, timbre, pitch, sound effects (such as explosion sound effects, metal sound effects, water flow sound effects, funny sound effects), duration, etc. The action attribute description information of the target sub-object may include but is not limited to the movement of the target sub-objects themselves (such as running, jumping), the action applied to the tool (such as holding, grabbing, lifting), etc. The change attribute description information of the target sub-object may include but is not limited to the change of line thickness, hue, volume/pitch, etc. of the target sub-objects, such as the line gradually becoming thicker or the volume gradually becoming smaller.

According to the needs, in the process of creating each sub-object of the at least one sub-object for generating the target object, the user may select/specify the required target sub-objects from the created sub-objects based on the corresponding selection/specification operation, and set the attributes to obtain the attribute description information of the target sub-objects; or load the existing content objects, select/specify the required target sub-objects from sub-objects contained in the loaded objects based on the corresponding selection/specification operation, and set the attributes to obtain the attribute description information of the target sub-objects, without limitation.

For example, in the process of drawing an image on an electronic device, the user may select the corresponding lines or areas from the drawn local lines or local areas as the target sub-objects, and set the attributes such as color, saturation, display style, rendering effect, etc. Or, the user may load a picture locally on the electronic device or download it from the network, select the corresponding local lines or local areas from the loaded picture as the target sub-objects, and set any one or more of the above display attributes as needed.

In implementation, for an image (or a portion of an image) drawn by the user, or for an image loaded by the user, the drawn image/partial image or loaded image may be analyzed for details such as local lines and local areas to obtain the sub-objects of the drawn image/partial image or loaded image that may be used for selection and attribute editing.

Step 102, a target file including the target objects is generated according to the attribute description information.

The target file may be, but is not limited to, a picture, an audio clip, a video clip, or an atlas, a slide, a document, etc., depending on the actual application.

After obtaining the attribute description information of the target sub-object, generating the target file including the target objects may be generated according to the attribute description information, may include, but is not limited to, generating the presentation effects of the target sub-objects based on the attribute description information of the target sub-objects, and generating an overall presentation effect of the target objects based on the presentation effect of the target sub-objects, to generate the target file including the target objects. For example, local polishing may be performed on the target sub-objects (such as local lines or local areas) based on the color description information of the target sub-objects, to generate an overall color theme for the target object based on the local polishing of the target sub-objects, etc.

The target sub-objects may present the presentation effects indicated by the attribute description information in the generated target file. Taking one target sub-object as a local lines or a local area in the drawn image as an example, the line or area may present the color, saturation and/or rendering effect and other display effects indicated by its display attribute description information in the generated target image. Taking the target sub-object as a voice clip as another example, the voice clip may present the volume, timbre, pitch and/or sound effect and other audio effects indicated by its audio attribute description information in the generated audio file.

In some embodiments, the target file including the target object may be generated according to the attribute description information through a generative artificial intelligence model such as an AIGC model.

When generating the target file including the target object according to the attribute description information based on the AIGC model, the attribute description information of the target sub-objects may be provided to the AIGC model in the form of a text description as a feature input based on the interactive method provided by AIGC, such that the AIGC model generates the target file including the target object according to the input attribute description information.

After generating the target file including the target object, the generated target file may be output on demand. For example, outputting the target file may include, but is not limited to, outputting the generated pictures, audio, video or atlas, slides, documents or any other types of target files on a single screen or multiple screens according to the actual needs of the application scenario. The corresponding output method may include display output, audio output or a combination of display and audio output, etc., which is not limited here. For example, the generated image may be output to the user's current display interface on a single screen, or the generated video may be output by combining display and audio, or multiple screens may be configured to output synchronously or asynchronously, etc.

In the data processing method provided in the above embodiments, refined attribute description and presentation effect generation/adjustment of local details (such as local lines and local areas of an image) of the target object in the generated content may be achieved as needed during content generation by obtaining the attribute description information of the target sub-objects (the attribute description information is configured to indicate the presentation effects of the target sub-objects in the target file) and generating the target file including the target object according to the attribute description information, thereby effectively meeting the real needs of users for the generated content during content generation.

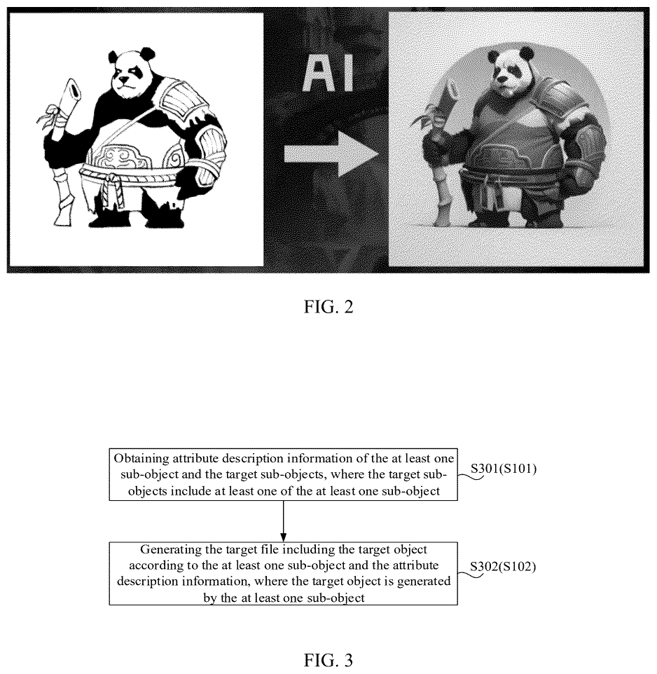

When AIGC is configured to generate images and other required content in existing technologies, it is necessary to describe the requirements of the content to be generated as a whole. For example, it is necessary to describe the overall picture style, color, or rendering effect of the image to be generated. And then the AIGC model generates the target object image corresponding to the overall picture display effect based on the overall description information. As shown in the example provided in FIG. 2, by describing the overall attributes of the drawn panda, a picture with the corresponding overall picture effect is generated, and it is impossible to perform special processing on local details. The data processing method provided in the embodiments of the present disclosure may overcome this problem. In the present disclosure, the local details of the target object in the generated content may be refined in the attribute description and presentation effect generation/adjustment as needed, which further improves the accuracy and precision of content generation, and may effectively meet the personalized requirements of users for local details in content generation, solving the problem that the known technology is difficult to meet the real needs of users when generating content.

In one embodiment as shown in FIG. 3 which is a flowchart of another data processing method consistent with the present disclosure, S101, i.e., obtaining the attribute description information of the target sub-objects, may include:

S301, obtaining the attribute description information of the at least one sub-object and the target sub-objects, where the target sub-objects include at least one of the at least one sub-object.

The at least one sub-object may be respectively corresponding sub-objects for generating the target object, such as local lines, local drawing areas, an overall drawing sketch, etc. for generating an image.

The attribute description information of the at least one sub-object for generating the target object and the target sub-objects may be obtained, such as obtaining each local line and each local area for generating an image, and obtaining the display attribute description information of the color, saturation, style, rendering effect, etc. of the specified target local line or target local area, to provide a data basis for the subsequent generation of the target file including the target object.

Correspondingly, as shown in FIG. 3, S102, i.e., generating the target file including the target object according to the attribute description information, may include:

S302, generating the target file including the target object according to the attribute description information of the at least one sub-object and the target sub-objects, where the target object is generated by the at least one sub-object.

S302 may include at least part of the following processing procedures 11)-13).

11) Generate the target object using the at least one sub-object obtained.

For example, a trunk and limbs of a panda may be generated using the obtained panda head image, to further generate a complete panda image, or a complete panda image including the trunk, head and limbs may be generated using the obtained panda trunk image, or a complete panda image may be generated using the obtained panda head, trunk, limbs and other sub-object images, etc.

12) According to the obtained attribute description information of the target sub-objects, adjust the corresponding effect parameters of the target sub-objects in the target object (the effect parameters corresponding to the attribute description information) such that the target sub-objects present the presentation effects indicated by the attribute description information in the target object.

For example, 12) may include but is not limited to: adjusting the corresponding display parameters and/or audio parameters of the target sub-objects in the target object (the display parameters and/or audio parameters corresponding to the attribute description information), such that the target sub-objects present the display effects and/or audio effects indicated by the attribute description information in the target object.

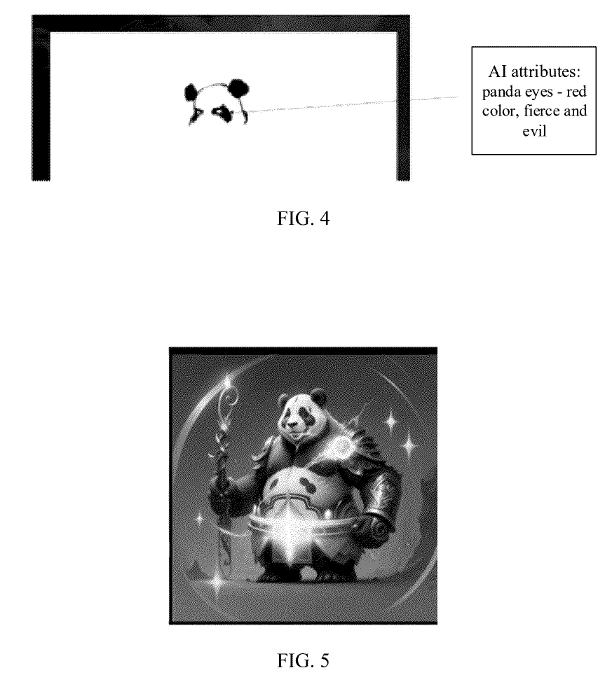

For example, as shown in FIG. 4, assuming that the target sub-objects include a panda's eyes and its attribute description information includes “panda eyes-red color, fierce and evil”, the display color of the panda's eyes in the generated panda image may be adjusted to red, and the display style may be adjusted to “fierce and evil”, to obtain the display effects indicated by the attribute description information of the panda's eyes.

13) Use the obtained attribute description information of the target sub-objects, to complete the presentation effects of the current sub-objects of the target object and obtain the complete target object, to generate an object file containing the target object.

The attribute information of other sub-objects other than the target sub-objects in the current sub-objects of the target object, including but not limited to the presentation effect parameters such as display parameters and/or audio parameters of the other sub-objects, may be first determined according to the attribute description information of the target sub-objects. And then, the current presentation effect parameters of the other sub-objects in the target object may be adjusted according to the determined presentation effect parameters such as display parameters and/or audio parameters. Preferably, the display parameters and/or audio parameters of the other sub-objects may match the display parameters and/or audio parameters corresponding to the attribute description information of the target sub-objects, to obtain the target object with coordinated overall presentation effects of each local detail.

For example, assuming that the target object may be a panda image and the target sub-objects may be the eyes of the panda, after adjusting the display parameters of the eyes of the panda through the attribute description information of FIG. 4, the color theme and display style of other components of the panda, such as the head, trunk, or limbs, may be further determined based on the attribute description information of the eyes of the panda, and the display parameters of each component other than the eyes may be adjusted based on the determined color theme and display style, and finally a panda image with a corresponding color theme and display style may be obtained, as shown in FIG. 5.

In actual applications, the user may set the attributes of the target sub-objects in the process of constructing each sub-object of the target object to obtain the attribute description information of the target sub-objects, and adjust the effect parameters of the target sub-objects based on the attribute description information. With the construction process of each sub-object of the target object and the gradual adjustment of the effect parameters of each target sub-object, the target file including the target object may be finally generated, and each target sub-object may present the presentation effect indicated by its attribute description information in the target file. Alternatively, an existing content object may be loaded, and the required target sub-objects may be selected/specified from it for attribute setting to obtain the attribute description information of the target sub-objects, and then the display/audio and other effect parameters of the target sub-objects may be adjusted based on the attribute description information of the target sub-objects, to finally generate the target file including the target object. In the case where the loaded content object is an image, the local and overall AI image generation may be performed synchronously based on the attribute description information of the target sub-objects, or the AI image generation may be performed in layers, where the image generation refers to the image content generation.

For example, during the drawing process, the user may assign AI feature attributes to each local line and each local area drawn, thereby generating attribute description information for each local line and local area, such as color, style, rendering effect, etc., and scheduling the AIGC model to input the attribute description information into the model. The AIGC model may capture the user's attribute description information of the drawn lines and local areas through multiple levels, and perform AI image generation in layers. As the drawing process progresses, an image that meets the user's requirements may be finally obtained, achieving the effect of AI empowerment while drawing.

For another example, the user may inject an AI attribute description into the loaded existing picture. The AI attribute description may be an attribute description of the overall picture. The AIGC model may generate a new AI picture that meets the overall attribute description information based on the overall attribute description information of the existing picture. Then, the local attribute description of the local lines, local areas, etc. in the generated picture may be further performed as needed. The AIGC model may adjust the local detail effects based on the injected local attribute description information, and generate hierarchical pictures that meet the overall and local needs of the user.

For yet another example, for the loaded existing picture, the attribute description of the overall picture and the local attribute description may be performed, and the picture with the overall and local attribute description may be loaded into the AIGC model. The model may directly generate a picture that meets the user's expectations by reading the attribute description information of local details such as local lines and local areas, as well as the overall attribute description information of the picture. Both the overall and detailed designs may meet the user's needs.

In this embodiment, refined attribute description and presentation effect generation/adjustment on the local details of the target object in the generated content may be achieved as needed, further improving the accuracy and precision of content generation to effectively meet the personalized requirements of users for local details during content generation, and solving the problem that the content generated in the existing technology is difficult to meet the real needs of users during content generation. Further, the presentation effect of each sub-object currently existing in the target object may be supplemented according to the attribute description information of the target sub-objects, to obtain the generated content (such as image content) with a coordinated and natural overall presentation effect.

In an optional embodiment, S101, i.e., obtaining the attribute description information of the target sub-objects, may include, but is not limited to, at least one of the following.

21) Obtaining annotation information for the target sub-objects input by the target user, and using the annotation information or first target information represented by the annotation information as the attribute description information of the target sub-objects.

The target user may be a user with operation authority and passed the authority verification, or may also be a user currently performing operations such as image drawing or voice input.

Optionally, for each sub-object configured to generate the target object, a comment box, comment position or comment layer that may be configured to set the attributes of the sub-object may be set respectively. And, optionally, the set comment box, comment position or comment layer may be hidden by default. When the user needs to set the attributes of the corresponding target sub-object, the comment box, comment position or comment layer of the target sub-object may be called up (for example, by selecting or clicking the required target sub-object to call up the comment box corresponding to the target sub-object), and the required comment information may be input into the called comment box, comment position or comment layer. The comment information may include setting information of the attribute settings performed on certain local lines or voice fragments of the target sub-objects.

The annotation information input to the target sub-object may be directly used as the attribute description information of the target sub-object, but it is not limited to this. In some other embodiments, the first target information represented by the annotation information may also be used as the attribute description information of the target sub-object. For example, the semantic content of the annotation information may be obtained first, and then the attribute description information in a standard format (that is, the first target information represented by the annotation information) may be generated based on the semantic content, such as display attribute parameters and/or audio attribute parameters and other parameter values, and the attribute description information in the standard format may be used as the attribute description information of the target sub-object.

22) Obtaining additional information input to a target area by the target user, and using the additional information or the second target information represented by the additional information as the attribute description information of the target sub-objects.

Optionally, the target area may be an area associated with the current application interface of the target user that may be used for information input to set the attributes of the sub-objects (the sub-objects for generating the target object) in the current application interface. The target user may input the additional information (such as prompt information or instruction information) of the target sub-objects into the target area to set the attributes of the target sub-objects, to obtain the attribute description information of the target sub-objects.

The obtained additional information may be directly used as the attribute description information of the target sub-objects. Alternatively, the second target information represented by the additional information may also be used as the attribute description information of the target sub-objects. For example, the semantic content of the additional information may be obtained first, and then the attribute description information in a standard format (i.e., the second target information represented by the additional information) may be generated based on the semantic content, such as display attribute parameters and/or audio attribute parameters and other parameter values, and the attribute description information in the standard format may be used as the attribute description information of the target sub-objects.

23) Obtaining behavior parameters of the target user when inputting the target sub-objects, and obtaining the attribute description information of the target sub-objects based on the behavior parameters.

The behavior parameters may include but are not limited to any one or more of the strength, speed, tone, intonation, etc. of the target user when inputting the target sub-objects.

The target user's behavior parameters such as strength, speed, tone and/or intonation when inputting the target sub-objects may be obtained, and the attribute description information of the target sub-objects may be determined based on the above behavior parameters. For example, strong strength may indicate anger, fast speed may indicate happiness, high intonation may indicate anger, etc.

24) Obtaining the display parameters and/or audio parameters of the target sub-objects, and obtaining the attribute description information of the target sub-objects based on the display parameters or audio parameters.

The display parameters may include but are not limited to the line thickness, color brightness, color concentration or other information configured for the target sub-objects, and the audio parameters may include but are not limited to the volume, timbre, tone, sound effects or other information configured for the target sub-objects.

The display parameters and/or audio parameters set for the target sub-objects may be obtained, and the obtained display parameters and/or audio parameters may be directly used as the attribute description information of the target sub-object. Or the obtained display parameters and/or audio parameters may be standardized, and the obtained standardized parameter information may be used as the attribute description information of the target sub-objects.

25) Obtaining the timing information of the sub-objects input by the target user and the additional information input to the target area, and obtaining the attribute description information of the target sub-objects based on the timing information.

The attribute description information of the target sub-objects may be obtained based on the timing information, which may be further implemented as the following 31)-32).

31) When a first target sub-object input by the target user and the first additional information input to the first target area are separated by a first time length, the first additional information or the target information represented by the first additional information is used as the attribute description information of the first target sub-object.

The first time length may be less than the first threshold.

Optionally, this situation 31) may correspond to the application scenario in which the user inputs/constructs the first target sub-object while enabling AI attributes for it, for example, enabling AI attributes for the drawn local lines/local areas while drawing. In this way, the target user may input/construct a part of the lines or drawing areas or voice segments, annotate or add additional information to the lines, drawing areas or voice segments, and use the annotation information/additional information, or the target information represented by the annotation information/additional information (such as standardized display parameters/audio parameters, etc.) as the attribute description information of the lines or drawing areas or voice segments.

32) When second additional information input by the target user into a second target area is separated from the currently existing sub-object by a second time length, based on the association operation between the second additional information and the second target sub-object, the second additional information or the target information represented by the second additional information may be used as the attribute description information of the second target sub-object, and the second target sub-object may include at least one of the currently existing sub-objects.

The second time length may be larger than a second threshold.

This situation 32) may be equivalent to the target user adding/setting attribute information to the corresponding sub-object constructed previously after completing the construction of the entire target object or a partial sub-object thereof, such as adding attribute information to the corresponding sub-object drawn previously after completing the drawing of the entire image or a partial image.

The association operation may be an operation in which the target user adds an annotation after clicking on the relevant sub-object, or inputs relevant information that is able to characterize the target sub-object, or adds additional information to the target area near the target sub-object, etc.

In this case, the second additional information or the target information represented by the second additional information may be used as the attribute description information of the second target sub-object based on the association operation between the second additional information and the second target sub-object, and the second target sub-object may be at least one of the currently existing sub-objects.

Based on this embodiment, the attribute description information of the target sub-objects may be obtained in a variety of ways. Correspondingly, the target user may configure/input the attributes of the target sub-objects through a variety of operation methods as needed, further improving the flexibility and convenience of user operations. It may be convenient for users to efficiently and quickly assign required attributes to local details as needed for their application scenarios (such as AI empowerment while drawing, or setting attributes of sub-objects for the completed target object) to adjust the presentation effect in a refined manner, thereby improving the efficiency and effect of content generation, reducing user operation steps and saving time.

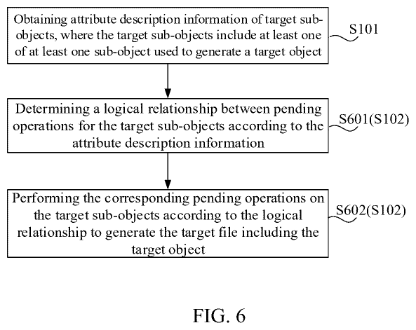

In an optional embodiment, as shown in FIG. 6 which is a flowchart of another data processing method flow consistent with the present disclosure, S102, i.e., generating the target file including the target object according to the attribute description information, may include S601 to S602.

At S601, a logical relationship between pending operations for the target sub-objects and the pending operations is determined according to the attribute description information.

In one embodiment, the pending operations for the target sub-objects may be determined according to the display attribute description information, audio attribute description information, action attribute description information and/or change attribute description information of the target sub-objects. For example, according to the display attribute description information such as the color or rendering effect of the target sub-objects, it may be determined that the pending operations for the target sub-objects include the adjustment/addition operation of the display parameters such as color and rendering effect; according to the audio attribute description information such as the volume, pitch, special effect sound, etc. of the target sub-objects, it may be determined that the pending operations for the target sub-objects include the adjustment/addition operation of audio parameters such as volume, pitch, special effect sound, etc.

The logical relationship between the pending operations, including but not limited to the order or hierarchical relationship between different pending operations, such as the hierarchical relationship or order relationship caused by different operations for different layers when generating an image, may be further determined.

At 602, corresponding processing operations on the target sub-objects are performed according to the logical relationship to generate the target file including the target object.

Based on S601, the corresponding processing operations may continue to be performed on the target sub-objects according to the logical relationship between the pending operations. For example, the corresponding color adjustment operation, audio volume adjustment operation, rendering effect adjustment operation, etc. may be performed on the target sub-objects according to the corresponding order or hierarchical relationship.

In one embodiment, S602 may include at least one of 41) to 43).

41) When one target sub-object is unique but the pending operations for the unique target sub-object are not unique, the target sub-object may be processed according to the temporal relationship between the pending operations and/or the spatial relationship between the operated objects acted on by the pending operations, to generate the target file including the target object.

The temporal relationship may be configured to characterize the order between different pending operations.

The spatial relationship between the operated objects acted on by the pending operations may be understood as the hierarchical relationship between the layers of the different operated objects acted on by the different pending operations, or the relationship between the tracks, etc.

For example, assuming that the target sub-object is a video clip, and assuming that the pending operations on the video clip include hue adjustment, rendering effect adjustment, volume adjustment, special effect addition, etc., the video clip may be processed with corresponding hue adjustment, rendering effect addition, volume adjustment, special effect addition, etc. according to the sequence, hierarchical relationship, and relationship between the tracks, etc. between the different operated objects such as video materials, audio tracks, display special effects, special effect sounds, etc. acted on by the above-mentioned different pending operations, to generate the video file including the video clip.

42) When the target sub-objects are not unique, but the pending operations for each target sub-object are unique, the target sub-objects may be processed according to the temporal relationship between the pending operations and/or the spatial relationship between the target sub-objects, to generate the target file including the target object.

The temporal relationship and spatial relationship here may be referred to the above description.

In this case 42), the corresponding target sub-objects may be processed according to the order of the pending operations represented by the temporal relationship, the hierarchical relationship between the layers of the different objects to be processed represented by the spatial relationship, or the relationship between the tracks, etc., to generate the target file including the target object.

For example, assuming that the multiple target sub-objects are different local lines and/or local areas in the drawn panda image, and each local line or local area corresponds to one pending operation in the operations such as hue adjustment or rendering effect addition, the local lines or local areas may be processed according to the order of the pending operations corresponding to the different local lines and/or local areas, the hierarchical relationship between the layers, etc., such as adjusting the color of the local lines, applying the corresponding rendering effect to the local areas, etc., to generate an image file including the panda image.

43) In the case where the target sub-objects are not unique and the pending operations for each target sub-object are not unique, the target sub-objects may be processed according to the temporal relationship between the pending operations, the spatial relationship between the operated objects acted by the pending operations, or the influence relationship between the target sub-objects, to generate the target file including the target object.

The temporal relationship and spatial relationship here may also refer to the relevant description above.

The influence relationship between the target sub-objects may include but is not limited to whether there is an influence between the target sub-objects, or the influence ratio when there is an influence, such as, for example, whether the size and hue of two interconnected local areas are affected, or the influence ratio of the size value and hue value of another area when there is an influence and the size and hue of one area need to be adjusted.

In this case 43), the corresponding target sub-objects may be processed according to the order between the pending operations represented by the temporal relationship, the hierarchical relationship between the layers or the relationship between the tracks of the different operated objects acted by the different pending operations represented by the spatial relationship, and/or whether there is an influence between different target sub-objects, and the influence ratio when there is an influence.

For example, assuming that multiple target sub-objects include different local lines and/or local areas in the drawn panda image, and each local line or local area corresponds to multiple pending operations in operations such as hue adjustment or rendering effect application, the multiple operations may be performed on different local lines or local areas according to the order of pending operations corresponding to different target sub-objects, the hierarchical relationship between the layers, whether there is an impact between different target sub-objects, and the impact ratio when there is an impact, etc., such as color adjustment and rendering effect application on a certain local area, and adjusting the size and hue of a certain local area according to the affected ratio to generate an image file including the panda image.

In this embodiment, the attribute description information of the target sub-objects may be used as a basis to perform refined presentation effect generation/adjustment on the local details of the target object in the content to be generated, the accuracy and precision of content generation may be improved, and the personalized requirements of users for local details in content generation may be effectively met. In combination with the description of the above embodiments, the present disclosure may support users to assign required attributes to local details through convenient operations to adjust their presentation effects in a refined manner, thereby improving content generation efficiency and effect, reducing user operation steps and saving time.

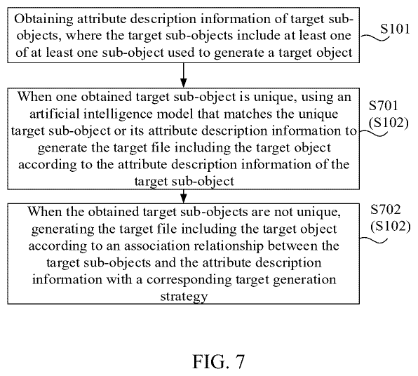

In one optional embodiment, as shown in FIG. 7, which is a flowchart of another data processing method consistent with the present disclosure, S102, i.e., generating the target file including the target object according to the attribute description information, may include S701 and S702.

At S701, when the obtained target sub-objects are unique, using an artificial intelligence model that matches the unique target sub-objects or their attribute description information to generate the target file including the target object according to the attribute description information of the target sub-objects.

The artificial intelligence model that matches the target sub-objects or their attribute description information may include, but is not limited to, a professional model or a refined processing model that matches the target sub-objects or their attribute description information. When the obtained target sub-objects are unique, the corresponding professional model or refined processing mode may be called, and the called model may be configured to generate the target file including the target object according to the attribute description information of the target sub-objects.

For example, the raw image (image generation) model may be called for image generation, the audio model may be called for speech generation, and the video generation model or the animated image generation model may be called when there is an attribute for applying an action. The attribute description information of the target sub-objects may be input as input features into the called model, such that the model generates the target file including the target object based on the attribute description information of the target sub-objects. In the generated target file, the target sub-objects may present the presentation effects indicated by the attribute description information.

At S702, in the case where the obtained target sub-objects are not unique, the target file including the target object is generated according to the association relationship between the target sub-objects and the attribute description information with the corresponding target generation strategy.

The association relationship between the target sub-objects may include but is not limited to the position relationship or proportional relationship between the target sub-objects.

In one embodiment, S702 may include at least one of 51) to 53).

51) According to the positional relationship between the target sub-objects, the attribute description information of the target sub-objects may be adjusted, and the target file including the target object may be generated according to the adjusted attribute description information.

Optionally, the association information or difference information between the attribute description information of different target sub-objects may be adjusted according to the positional relationship between different target sub-objects, such as increasing the difference information or reducing the difference information, or enhancing the association information or weakening the association information, etc.

For example, according to the positional relationship between different local areas in the panda image, the color difference between different local areas may be enhanced or reduced.

According to the adjusted attribute description information corresponding to the target sub-objects, the target file including the target object may be generated. In the generated target file, the target sub-objects correspondingly may present the presentation effects indicated by the adjusted attribute description information.

52) According to the proportional relationship between the target sub-objects, the attribute description information of the target sub-objects may be adjusted, and the target file including the target object may be generated according to the adjusted attribute description information.

In addition to the positional relationship, the attribute description information of the target sub-objects may also be adjusted according to the proportional relationship between the target sub-objects. For example, it may be possible but not limited to adjust the association information or difference information between the attribute description information of different target sub-objects according to the proportional relationship between different target sub-objects, such as increasing the difference information or reducing the difference information, or enhancing the association information or weakening the association information, etc.

For example, according to the proportional relationship between different local areas in the panda image, the special effect difference between different local areas may be enhanced or reduced, or the width of the boundary line between different local areas may be increased or reduced.

According to the adjusted attribute description information corresponding to the target sub-objects, the target file including the target object may be generated. In the generated target file, the target sub-objects may correspondingly present the presentation effects indicated by the adjusted attribute description information.

53) The attribute description information of the target sub-objects may be adjusted according to the positional relationship or proportional relationship between the target sub-objects and the other sub-objects obtained, and the target file including the target object may be generated according to the adjusted attribute description information.

For example, the attribute description information of the target sub-objects and the other sub-objects may be optimized and adjusted according to the positional relationship or proportional relationship between the target sub-objects and the other sub-objects obtained, to prevent the positional relationship or proportional relationship between the target sub-objects and the other sub-objects from affecting the boundary or clarity between the target sub-objects and the other sub-objects obtained. For example, the contrast of the local area of the panda target and other local areas may be improved, the sharpness may be improved, etc., to avoid affecting the clarity or boundary of different local areas.

In one embodiment, in the case where the obtained target sub-objects are not unique, a generative AI model, i.e., an AIGC model, may be configured to generate the target file including the target object through the above processing process. Or, multiple generative AI models, i.e., multiple AIGC models, may be configured to generate corresponding local content for each target sub-object, and finally the target file including the target object may be obtained through merging processing. For example, for each target sub-object, a professional model or refined processing matching the target sub-object or its attribute description information may be called respectively, and the refined presentation effect adjustment and generation for the target sub-object may be performed, and finally, the target file including the target object may be obtained by merging the generation results of the refined presentation effects of each model for different target sub-objects.

In the present embodiment, for the situation that the obtained target sub-objects may be not unique, when generating the target file including the target object according to the attribute description information of the target sub-objects, the position relationship, proportion relationship or other association relationships between the target sub-objects may be also considered, which may better reflect the differentiation between different target sub-objects or synchronize the associated attributes of related sub-objects, thereby further improving the overall presentation effect of the object content (such as image content) in the target object finally generated.

In an optional embodiment, S102, i.e., generating the target file including the target object according to the attribute description information, may include at least one of 61) to 64).

61) After generating and processing at least one first target sub-object according to the first attribute description information of the at least one first target sub-object to obtain first sub-objects, the first sub-objects and the other sub-objects obtained may be input into the corresponding artificial intelligence model, to use the artificial intelligence model to generate at least one of the pictures, animated pictures, videos, audios, or documents including the target object.

The other sub-objects may include other target sub-objects other than the at least one first target sub-object, for example, second target sub-objects.

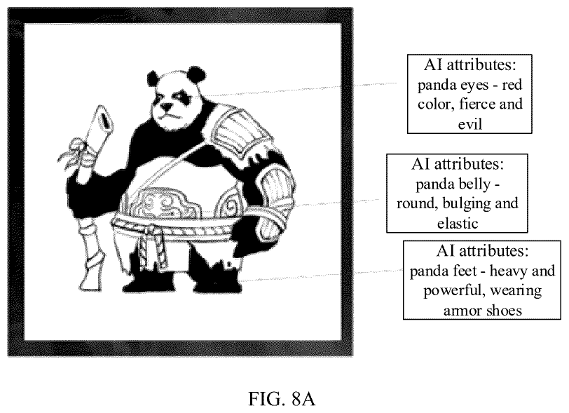

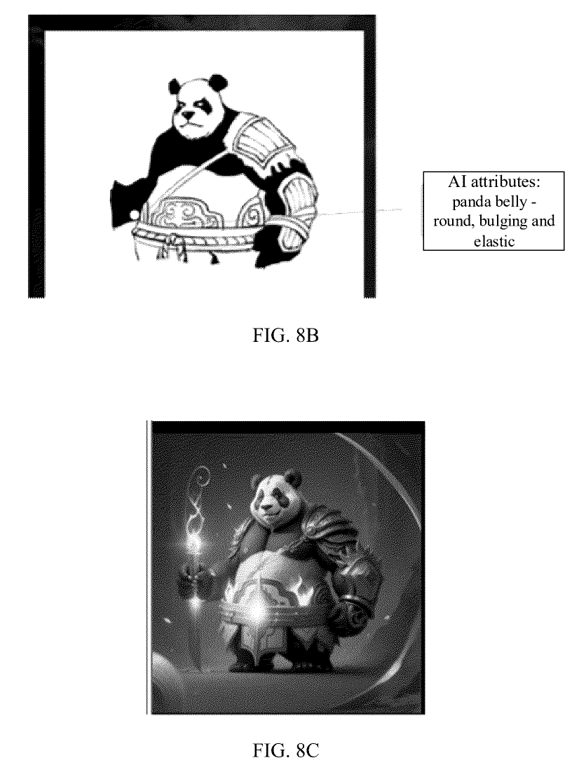

For example, the at least one first target sub-object may be generated and processed according to the first attribute description information of the at least one first target sub-object to obtain the corresponding first sub-objects. For example, referring to the example of FIG. 8A, assuming that the target sub-objects include panda eyes, panda belly and panda feet, and assuming that the at least one first target sub-object may be a panda belly, as shown in FIG. 8(b), the panda belly with a corresponding presentation effect may be generated according to the first attribute description information of the panda belly, such as “round, bulging and elastic”. On this basis, the generated panda belly with the corresponding presentation effect and other sub-objects may be input into an artificial intelligence model such as AIGC. For example, the second target sub-objects such as the panda belly and panda feet carrying the attribute description information in FIG. 8A and sub-objects other than the target sub-objects (such as the panda arm), may be input into AIGC, to generate at least one of the pictures, animated pictures, videos, audios, or documents, including the target object using artificial intelligence models such as AIGC. For example, a panda image as shown in FIG. 8C may be generated.

62) After the target sub-objects are generated according to the attribute description information of the target sub-objects, the generated objects and other sub-objects obtained may be input into the corresponding artificial intelligence model, to use the artificial intelligence model to generate at least one of the pictures, animated pictures, videos, audios, or documents including the target object.

Different from 61), in 62), after considering the local content generation of all target sub-objects, the content generation may be combined with other non-target sub-objects. For example, after considering the raw images of all target sub-objects, the raw images may be combined with other non-target sub-objects. The raw images here may be the generated image content.

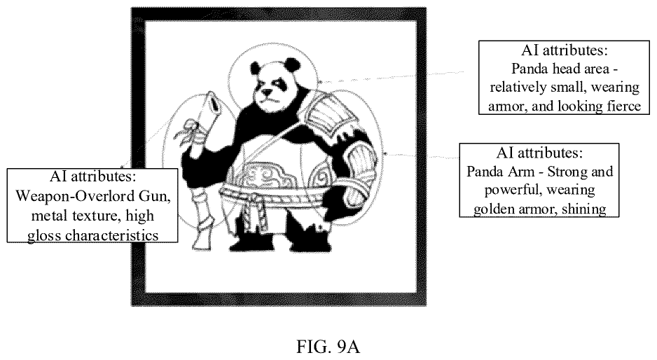

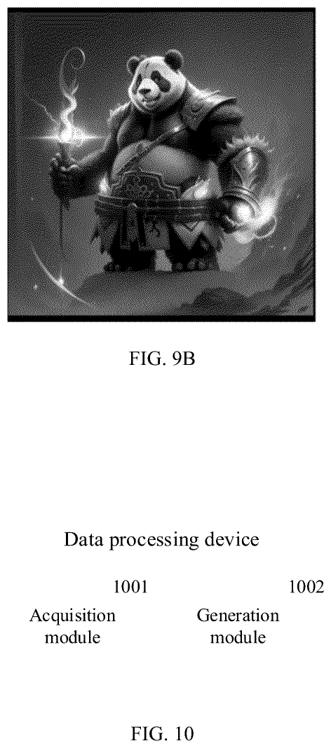

For example, as shown in FIG. 9A, assuming that the user sets the panda head area, arms, and tools in the drawn panda image as target sub-objects and inputs corresponding attribute description information for them respectively, the local image contents of these three target sub-objects may be generated according to the corresponding attribute description information. On this basis, the generated local area image and other sub-objects may be input into AIGC or other artificial intelligence models to generate at least one of the pictures, animated pictures, videos, audios, or documents including the target object using AIGC and other artificial intelligence models, for example, to generate a panda image as shown in FIG. 9B.

63) After a first generation process is performed according to the attribute description information and the obtained sub-objects, the generated objects may be input into the corresponding artificial intelligence model again to generate at least one of the pictures, animated pictures, videos, audios, or documents including the target object.

The two generation processes involved here may use different AI models, or may also use the same AI model, such as using the same or different AIGC models, etc., which is not limited here.

For example, after inputting the attribute description information of the panda's eyes and belly and the obtained sub-objects (such as the panda's eyes, arms, belly, feet, or tools) into the AIGC model and using the model to generate a panda image with the required attributes, the same AIGC model may be used again to generate an animated image or video with the panda image.

64) The spatial environment information of the electronic device may be obtained, and at least one of the pictures, animated pictures, videos, audios, or documents including the target object may be generated according to the spatial environment information and the attribute description information, where the electronic device is a device for generating the target file.

The spatial environment information of the electronic device may include but is not limited to any one or more of the brightness, color, volume, or tone of the space where the electronic device is located.

In this embodiment, the target file may be generated in combination with the environmental factors of the environment where the electronic device is located. For example, the attribute description information of the target sub-objects may be adjusted according to the spatial environment information such as the brightness, color, volume, or tone of the space where the electronic device is located. For example, when the spatial brightness is too high, the brightness value in the attribute description information may be increased, and when the spatial volume is too high, the volume value in the attribute description information may be increased. At least one of the pictures, animated pictures, videos, audios, or documents including the target object may be generated according to the adjusted attribute description information. However, it is not limited to this. In actual applications, the target object may also be generated according to the attribute description information of the target sub-objects first, and then the overall brightness, color, volume, and tone of the target object may be adjusted according to the spatial environment information such as the spatial brightness, color, volume, and tone.

Based on this embodiment, the required target file including pictures, animated images, videos, audios, documents, etc. of the target object may be obtained in various ways and through one or two content generation. In the content generation, the user may be supported to make fine settings for local details as required, and the content generation process may be optimized and adjusted in combination with the spatial environment information of the space where the electronic device is located, not only effectively meeting the user's personalized requirements for local details in content generation, but also solving the problem that the existing technology is difficult to meet the user's real needs when generating content. The generated content may match with the spatial environment of the space described by the user, further improving the presentation effect of the generated content.

The present disclosure also provides a data processing device. As shown in FIG. 10, in one embodiment, the data processing device may include:
an acquisition module 1001, configured to obtain attribute description information of target sub-objects, where the target sub-objects may include at least one of at least one sub-object configured to generate a target object; and
a generation module 1002, configured to generate a target file including the target object according to the attribute description information.

The attribute description information may be configured to indicate the presentation effects of the target sub-objects in the target file.

In one embodiment, the acquisition module 1001 may be configured to: obtain the attribute description information of the at least one sub-object and the target sub-objects, where the target sub-objects may include at least one of the at least one sub-object.

The generation module 1002 may be configured to: generate the target file including the target object according to the at least one sub-object and the attribute description information, where the target object may be generated by the at least one sub-object.

In one embodiment, the acquisition module 1001 may be configured to perform at least one of:
obtaining annotation information for the target sub-objects input by a target user, and using the annotation information or the first target information represented by the annotation information as the attribute description information of the target sub-objects;
obtaining additional information input to a target area by a target user, and using the additional information or the second target information represented by the additional information as the attribute description information of the target sub-objects;
obtaining the behavior parameters of the target user when inputting the target sub-objects, and obtaining the attribute description information of the target sub-objects based on the behavior parameters;
obtaining the display parameters or audio parameters of the target sub-objects, and obtaining the attribute description information of the target sub-objects based on the display parameters or audio parameters; or
obtaining the timing information of the at least one sub-object input by the target user and the additional information input to the target area, and obtaining the attribute description information of the target sub-objects based on the timing information.

In one embodiment, the acquisition module 1001, when obtaining the attribute description information of the target sub-objects based on the timing information, may be configured to:
when a first target sub-object input by the target user and first additional information input to the first target area are separated by a first time length, use the first additional information or the target information represented by the first additional information as the attribute description information of the first target sub-object; or
when second additional information input by the target user to a second target area is separated by a second time length from currently existing sub-objects, based on the association operation between the second additional information and the second target sub-object, use the second additional information or the target information represented by the second additional information as the attribute description information of the second target sub-object, where the second target sub-object may include at least one of the currently existing sub-objects.

In one optional embodiment, the generation module 1002 may be configured to:
determine the logical relationship between the pending operations for the target sub-objects and the pending operation according to the attribute description information; and
perform the corresponding processing operation on the target sub-objects according to the logical relationship to generate the target file including the target object.

In one embodiment, the generation module 1002, when performing the corresponding processing operations on the target sub-objects according to the logical relationship to generate the target file including the target object, may be configured to perform at least one of:
when one target sub-object is unique but the pending operation for the unique target sub-object is not unique, processing the target sub-objects according to the temporal relationship between the pending operations and/or the spatial relationship between the operated objects acted on by the pending operations, to generate the target file including the target object;
when the target sub-objects are not unique but the pending operation for each target sub-object is unique, processing the target sub-objects according to the temporal relationship between the pending operations and/or the spatial relationship between the target sub-objects, to generate the target file including the target object; or
when the target sub-objects are not unique and the pending operation for each target sub-object is not unique, processing the target sub-objects according to the temporal relationship between the pending operations, the spatial relationship between the operated objects acted on by the pending operations, or the influence relationship between the target sub-objects, to generate the target file including the target object.

In one embodiment, the generation module 1002 may be configured to perform at least one of:
when one target sub-object obtained is unique, generating the target file including the target object according to the attribute description information of the target sub-objects using an artificial intelligence model that matches the unique target sub-object or its attribute description information; or
when the target sub-objects obtained are not unique, generating the target file including the target object according to the association relationship between the target sub-objects and the attribute description information using a corresponding target generation strategy.

In one embodiment, the generation module 1002, when generating the target file including the target object according to the association relationship between the target sub-objects and the attribute description information with the corresponding target generation strategy, may be configured to perform at least one of:
adjusting the attribute description information of the target sub-objects according to the positional relationship between the target sub-objects, and generating the target file including the target object according to the adjusted attribute description information;
adjusting the attribute description information of the target sub-objects according to the proportional relationship between the target sub-objects, and generating the target file including the target object according to the adjusted attribute description information; or
adjusting the attribute description information of the target sub-objects according to the positional relationship or proportional relationship between the target sub-objects and other obtained sub-objects, and generating the target file including the target object according to the adjusted attribute description information.

In one embodiment, the generation module 1002 may be configured to perform at least one of:
after generating the first target sub-object according to the first attribute description information of at least one first target sub-object to obtain the first sub-object, inputting the first sub-object and the other sub-objects obtained into the corresponding artificial intelligence model, to generate at least one of the pictures, animated pictures, videos, audios, or documents including the target object by using the artificial intelligence model;
after generating the target sub-objects according to the attribute description information of the target sub-objects, inputting the generated objects and the other sub-objects obtained into the corresponding artificial intelligence model to generate at least one of the pictures, animated pictures, videos, audios, or documents including the target object by using the artificial intelligence model;
after performing the first generation processing according to the attribute description information and the obtained sub-objects, inputting the generated objects into the corresponding artificial intelligence model again to generate at least one of the pictures, animated pictures, videos, audios, or documents including the target object; or
obtaining the spatial environment information of the electronic device, and generating at least one of the pictures, animated pictures, videos, audios, or documents including the target object according to the spatial environment information and the attribute description information, where the electronic device may be a device for generating the target file.

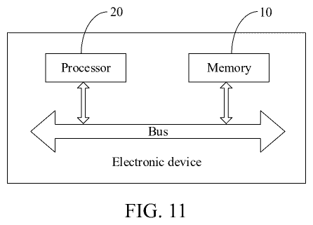

The present disclosure also provides an electronic device. As shown in FIG. 11, in one embodiment, the electronic device may at least include:
a memory 10, configured to store a computer instruction set, where the computer instruction set may be implemented in the form of a computer program; and
a processor 20, configured to implement the data processing method provided by any embodiment of the present disclosure, when executing the computer instruction set.

The processor 20 may be a central processing unit (CPU), an application-specific integrated circuit (ASIC), a digital signal processor (DSP), an application-specific integrated circuit (ASIC), a field programmable gate array (FPGA), a neural network processor (NPU), a deep learning processor (DPU) or other programmable logic devices, etc.

The electronic device may further include a display device and/or a display interface, or may be connected to an external display device.

Optionally, the electronic device may further include a camera component, and/or may be connected to an external camera component.

In addition, the electronic device may further include components such as a communication interface and a communication bus. The memory, the processor and the communication interface may communicate with each other through the communication bus.

The communication interface may be used for communication between the electronic device and other devices. The communication bus may be a Peripheral Component Interconnect (PCI) bus or an Extended Industry Standard Architecture (EISA) bus, etc. The communication bus may include an address bus, a data bus, a control bus, etc.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only configured to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the phrase “comprises a.” or “includes a” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A data processing method, comprising:
obtaining attribute description information of one or more target sub-objects, wherein the one or more target sub-objects include one or more of at least one sub-object configured to generate a target object; and
generating a target file including the target object according to the attribute description information, wherein:
the attribute description information is configured to indicate presentation effects of the target sub-objects in the target file.

2. The method according to claim 1, wherein:
obtaining the attribute description information of the one or more target sub-objects includes: obtaining attribute description information of the at least one sub-object and the target sub-objects, wherein the target sub-objects include one or more of the at least one sub-object; and
generating the target file including the target object according to the attribute description information includes: generating the target file including the target object according to the at least one sub-object and the attribute description information, wherein the target object is generated by the at least one sub-object.

3. The method according to claim 1, wherein:
obtaining the attribute description information of the target sub-objects includes at least one of:
obtaining annotation information for the target sub-objects input by a target user, and using the annotation information or first target information represented by the annotation information as the attribute description information of the target sub-objects;
obtaining additional information input by the target user to a target area, and using the additional information or second target information represented by the additional information as the attribute description information of the target sub-objects;
obtaining behavior parameters of the target user when inputting the target sub-objects, and obtaining the attribute description information of the target sub-objects based on the behavior parameters;
obtaining display parameters or audio parameters of the target sub-objects, and obtaining the attribute description information of the target sub-objects based on the display parameters or audio parameters; or
obtaining timing information of one sub-object input by the target user and additional information input to a target area, and obtaining the attribute description information of the target sub-objects based on the timing information.

4. The method according to claim 3, wherein:
obtaining the attribute description information of the target sub-objects based on the timing information includes:
when a first target sub-object input by the target user and first additional information input into a first target area are separated by a first time length, using the first additional information or the target information represented by the first additional information as the attribute description information of the first target sub-object; or
when second additional information input by the target user into a second target area is separated by a second time length from currently existing sub-objects, based on an association operation between the second additional information and the second target sub-object, using the second additional information or the target information represented by the second additional information as the attribute description information of the second target sub-object, where the second target sub-object is at least one of the currently existing sub-objects.

5. The method according to claim 1, wherein:
generating the target file including the target object according to the attribute description information includes:
determining a logical relationship between pending operations for the target sub-objects according to the attribute description information; and
performing the corresponding pending operations on the target sub-objects according to the logical relationship to generate the target file including the target object.

6. The method according to claim 5, wherein:
performing the corresponding pending operations on the target sub-objects according to the logical relationship to generate the target file including the target object, includes at least one of:
when the target sub-objects are unique and the pending operations for the unique target sub-objects are not unique, processing the target sub-objects according to a temporal relationship between the pending operations and/or spatial relationship between operated objects acted by the pending operations to generate the target file including the target object;
when the target sub-objects are not unique and the pending operations for each target sub-object are unique, processing the target sub-objects according to the temporal relationship between the pending operations and/or the spatial relationship between the target sub-objects to generate the target file including the target object; or
when the target sub-objects are not unique and the pending operations for each target sub-object are not unique, processing the target sub-objects according to the temporal relationship between the pending operations, the spatial relationship between the operated objects acted by the pending operations, or an influence relationship between the target sub-objects to generate the target file including the target object.

7. The method according to claim 1, wherein:
generating the target file including the target object according to the attribute description information includes at least one of:
when one obtained target sub-object is unique, using an artificial intelligence model that matches the unique target sub-object or its attribute description information to generate the target file including the target object according to the attribute description information of the target sub-object; or
when the obtained target sub-objects are not unique, generating the target file including the target object according to an association relationship between the target sub-objects and the attribute description information with a corresponding target generation strategy.

8. The method according to claim 7, wherein:
generate the target file including the target object according to the association relationship between the target sub-objects and the attribute description information with the corresponding target generation strategy, includes at least one of:
adjusting the attribute description information of the target sub-objects according to a positional relationship between the target sub-objects, and generating the target file including the target object according to the adjusted attribute description information;
adjusting the attribute description information of the target sub-objects according to a proportional relationship between the target sub-objects, and generating target file including the target object according to the adjusted attribute description information; or
adjusting the attribute description information of the target sub-object according to the positional relationship or the proportional relationship between the target sub-objects and other obtained sub-objects, and generating the target file including the target object according to the adjusted attribute description information.

9. The method according to claim 1, wherein:
generating the target file including the target object according to the attribute description information includes at least one of:
after performing generation processing on at least one first target sub-object according to first attribute description information of the at least one first target sub-object to obtain a first sub-object, inputting the first sub-object and the other sub-objects obtained into a corresponding artificial intelligence model to generate at least one of pictures, animated pictures, videos, audios, or documents including the target object, by using the artificial intelligence model;
after performing generation processing on the target sub-objects according to the attribute description information of the target sub-objects, inputting generated objects and other sub-objects obtained into a corresponding artificial intelligence model to generate at least one of pictures, animated pictures, videos, audios, or documents including the target object, by using the artificial intelligence model;
after performing first generation processing according to the attribute description information and the obtained sub-objects, inputting generated object into a corresponding artificial intelligence model again to generate at least one of pictures, animated pictures, videos, audios, or documents including the target object; or
obtaining spatial environment information of an electronic device, and generating at least one of pictures, animated pictures, videos, audios, or documents including the target object according to the spatial environment information and the attribute description information, wherein the electronic device is a device for generating the target file.

10. An electronic device, comprising:
one or more processors; and a memory containing at least one instruction that, when being executed, causes the one or more processors to perform:
obtaining attribute description information of one or more target sub-objects, wherein the one or more target sub-objects include one or more of at least one sub-object configured to generate a target object; and
generating a target file including the target object according to the attribute description information, wherein the attribute description information is configured to indicate presentation effects of the target sub-objects in the target file.

11. The device according to claim 10, wherein the one or more processors are further configured to perform:
obtaining attribute description information of the at least one sub-object and the target sub-objects, wherein the target sub-objects include one or more of the at least one sub-object; and
generating the target file including the target object according to the at least one sub-object and the attribute description information, wherein the target object is generated by the at least one sub-object.

12. The device according to claim 10, wherein the one or more processors are further configured to perform:
obtaining the attribute description information of the target sub-objects by at least one of:
obtaining annotation information for the target sub-objects input by a target user, and using the annotation information or first target information represented by the annotation information as the attribute description information of the target sub-objects;
obtaining additional information input by the target user to a target area, and using the additional information or second target information represented by the additional information as the attribute description information of the target sub-objects;
obtaining behavior parameters of the target user when inputting the target sub-objects, and obtaining the attribute description information of the target sub-objects based on the behavior parameters;
obtaining display parameters or audio parameters of the target sub-objects, and obtaining the attribute description information of the target sub-objects based on the display parameters or audio parameters; or
obtaining timing information of one sub-object input by the target user and additional information input to a target area, and obtaining the attribute description information of the target sub-objects based on the timing information.

13. The device according to claim 12, wherein the one or more processors are further configured to perform:
when a first target sub-object input by the target user and first additional information input into a first target area are separated by a first time length, using the first additional information or the target information represented by the first additional information as the attribute description information of the first target sub-object; or
when second additional information input by the target user into a second target area is separated by a second time length from currently existing sub-objects, based on an association operation between the second additional information and the second target sub-object, using the second additional information or the target information represented by the second additional information as the attribute description information of the second target sub-object, where the second target sub-object is at least one of the currently existing sub-objects.

14. The device according to claim 10, wherein the one or more processors are further configured to perform:
determining a logical relationship between pending operations for the target sub-objects according to the attribute description information; and
performing the corresponding pending operations on the target sub-objects according to the logical relationship to generate the target file including the target object.

15. The device according to claim 14, wherein the one or more processors are further configured to perform at least one of:
when the target sub-objects are unique and the pending operations for the unique target sub-objects are not unique, processing the target sub-objects according to a temporal relationship between the pending operations and/or spatial relationship between operated objects acted by the pending operations to generate the target file including the target object;
when the target sub-objects are not unique and the pending operations for each target sub-object are unique, processing the target sub-objects according to the temporal relationship between the pending operations and/or the spatial relationship between the target sub-objects to generate the target file including the target object; or
when the target sub-objects are not unique and the pending operations for each target sub-object are not unique, processing the target sub-objects according to the temporal relationship between the pending operations, the spatial relationship between the operated objects acted by the pending operations, or an influence relationship between the target sub-objects to generate the target file including the target object.

16. The device according to claim 10, wherein the one or more processors are further configured to perform at least one of:
when one obtained target sub-object is unique, using an artificial intelligence model that matches the unique target sub-object or its attribute description information to generate the target file including the target object according to the attribute description information of the target sub-object; or
when the obtained target sub-objects are not unique, generating the target file including the target object according to an association relationship between the target sub-objects and the attribute description information with a corresponding target generation strategy.

17. The device according to claim 16, wherein the one or more processors are further configured to perform at least one of:
adjusting the attribute description information of the target sub-objects according to a positional relationship between the target sub-objects, and generating the target file including the target object according to the adjusted attribute description information;
adjusting the attribute description information of the target sub-objects according to a proportional relationship between the target sub-objects, and generating target file including the target object according to the adjusted attribute description information; or
adjusting the attribute description information of the target sub-object according to the positional relationship or the proportional relationship between the target sub-objects and other obtained sub-objects, and generating the target file including the target object according to the adjusted attribute description information.

18. The device according to claim 10, wherein the one or more processors are further configured to perform at least one of:
after performing generation processing on at least one first target sub-object according to first attribute description information of the at least one first target sub-object to obtain a first sub-object, inputting the first sub-object and the other sub-objects obtained into a corresponding artificial intelligence model to generate at least one of pictures, animated pictures, videos, audios, or documents including the target object, by using the artificial intelligence model;
after performing generation processing on the target sub-objects according to the attribute description information of the target sub-objects, inputting generated objects and other sub-objects obtained into a corresponding artificial intelligence model to generate at least one of pictures, animated pictures, videos, audios, or documents including the target object, by using the artificial intelligence model;
after performing first generation processing according to the attribute description information and the obtained sub-objects, inputting generated object into a corresponding artificial intelligence model again to generate at least one of pictures, animated pictures, videos, audios, or documents including the target object; or
obtaining spatial environment information of an electronic device, and generating at least one of pictures, animated pictures, videos, audios, or documents including the target object according to the spatial environment information and the attribute description information, wherein the electronic device is a device for generating the target file.

19. A non-transitory computer readable storage medium containing at least one instruction that, when being executed, causes at least one processor to perform:
obtaining attribute description information of one or more target sub-objects, wherein the one or more target sub-objects include one or more of at least one sub-object configured to generate a target object; and
generating a target file including the target object according to the attribute description information, wherein the attribute description information indicates presentation effects of the target sub-objects in the target file.

20. The storage medium according to claim 19, wherein the at least one processor is further configured to perform:
obtaining attribute description information of the at least one sub-object and the target sub-objects, wherein the target sub-objects include one or more of the at least one sub-object; and
generating the target file including the target object according to the at least one sub-object and the attribute description information, wherein the target object is generated by the at least one sub-object.
